(19) United States
(12) Patent Application Publication
(10) Pub. No.: US 2026/0234935 A1
(43) Pub. Date: Aug. 13, 2026

(54) ROOF SYSTEM WITH ADHERED CONSTRUCTION BOARDS

(71) Applicant: Amrize Technology Switzerland LLC, Zug (CH)

(72) Inventors: Linyong SONG, Fishers, IN (US); Jiansheng TANG, Westfield, IN (US); Zengquan QIN, Brentwood, TN (US); Mark HOLTMAN, Fishers, IN (US); Joseph J. KALWARA, Indianapolis, IN (US); Joseph R. CARR, Indianapolis, IN (US)

(21) Appl. No.: 19/470,714

(22) PCT Filed: Mar. 26, 2024
(86) PCT No.: PCT/EP2024/058094

§ 371 Date: Sep. 29, 2025

Related U.S. Application Data
(60) Provisional application No. 63/493,472, filed on Mar. 31, 2023.

(51) Int. Cl. E04D 5/10; E04D 5/14; E04D 11/02

(52) U.S. Cl. CPC E04D 5/10; E04D 5/148; E04D 11/02

(57) ABSTRACT

A flat or low-sloped roof system including (i) a roof deck; (ii) a first layer of construction boards secured directly or indirectly to the roof deck; (iii) a second layer of construction boards adhered to the first layer of construction boards via a double-sided adhesive sheet that includes a first layer of pressure-sensitive adhesive and a second layer of pressure-sensitive adhesive sandwiching a foamed carrier layer; and (iv) a roofing membrane forming a waterproof protective layer over the second layer of construction boards. Other configurations and a method of installing construction boards on a roof are also provided.

### FIELD OF THE INVENTION

Embodiments of the present invention provide roof systems with one or more layers of construction boards adhered into the system through a double-sided adhesive sheet that includes a foamed carrier layer.

### BACKGROUND OF THE INVENTION

Pressure-sensitive adhesives have been used in the construction industry. For example, in the construction of low-sloped or flat roofs, polymeric single-ply membranes including a layer of pressure-sensitive adhesive have been used. The pressure-sensitive adhesive is used to secure the membrane to the underlying surface. The membrane provides a weather-protective layer for the roof system. These membrane composites are advantageously installed by the so-called “peel-and-stick” method. Numerous advantages are realized by using peel-and-stick methods including reduced installation time and labor, as well as the fact that the adhered systems can be formed without the use of significant volatile organic compounds.

Also, the construction of membranes carrying a pressure-sensitive adhesive is relatively straightforward since efficient techniques are available for applying the pressure-sensitive adhesive to the membrane within a factory setting. For example, the pressure-sensitive adhesive can be efficiently applied to the surface of a membrane as a hot-melt composition using relatively common coating techniques.

The skilled person appreciates that many flat or low-sloped roof systems also include one or more layers of construction board disposed between the roof deck and the membrane. In many situations, this may include a multi-layered assembly that includes, for example, two or more layers of insulation board and a layer of coverboard to protect the insulation board layer. The insulation boards, which are often referred to as board stock, can include a polyisocyanurate foam body that often ranges in thickness of from about 2 to about 4 inches. These boards also typically carry opposed facers that sandwich the foam body. In multi-layered roof systems, the bottom insulation layer is often mechanically fastened to the roof deck, and the subsequent layers, including the coverboard layer, can advantageously be adhered using, for example, a low-rise foam adhesive.

While low-rise foam adhesives are commonly used where there is a desire to adhere construction boards in place, it has also been proposed to factory-apply a pressure-sensitive adhesive to the facer of the boards. In other words, like the membranes that carry a pressure-sensitive adhesive layer, the construction boards can likewise be installed using the peel-and-stick installation method. These construction boards, however, have not been widely adopted.

### SUMMARY OF THE INVENTION

One or more embodiments of the present invention provide a flat or low-sloped roof system comprising (i) a roof deck; (ii) a first layer of construction boards secured directly or indirectly to the roof deck; (iii) a second layer of construction boards adhered to the first layer of construction board; and (iv) a roofing membrane forming a water-proof protective layer over the roof system, where the second layer of construction board is adhered to the first layer of construction boards through a double-sided adhesive sheet that includes first and second layers of pressure-sensitive adhesive sandwiching a foamed carrier layer.

Other embodiments of the present invention provide a method of installing construction boards on a roof, the method comprising (i) providing a double-sided adhesive sheet, where the adhesive sheet includes first and second layers of pressure-sensitive adhesive sandwiching a foamed carrier layer, the first layer of pressure-sensitive adhesive forming a bottom surface of the adhesive sheet and the second layer of pressure-sensitive adhesive forming an upper surface of the adhesive sheet; (ii) providing a first layer of construction boards secured to a roof deck; (iii) positioning the double-sided adhesive sheet on a desired exposed surface of the first layer of construction boards; (iv) contacting and adhering the bottom surface of the adhesive sheet to the first layer of construction boards; and (v) placing a second layer of construction boards into contact with the upper surface of the adhesive sheet.

Yet other embodiments of the present invention provide a method of installing construction boards on a roof, the method comprising (i) providing a double-sided adhesive sheet, where the adhesive sheet includes first and second layers of pressure-sensitive adhesive sandwiching a foamed carrier layer, the first layer of pressure-sensitive adhesive forming a bottom surface of the adhesive sheet and the second layer of pressure-sensitive adhesive forming an upper surface of the adhesive sheet; (ii) positioning the double-sided adhesive sheet on a desired area of a roof deck; (iii) contacting and adhering the bottom surface of the adhesive sheet to the roof deck; (iv) providing a plurality of construction boards; and (v) contacting and adhering the plurality of construction boards to the upper surface of the double-sided adhesive sheet to thereby form a layer of construction boards adhered to the roof deck.

Still other embodiments of the present invention provide the use of a double-sided adhesive sheet to secure construction boards into a roofing system by securing a plurality of construction boards to a layer of construction boards, where the adhesive sheet includes first and second layers of pressure-sensitive adhesive sandwiching a foamed carrier layer, the first layer of pressure-sensitive adhesive forming a bottom surface of the adhesive sheet and the second layer of pressure-sensitive adhesive forming an upper surface of the adhesive sheet.

Yet other embodiments of the present invention provide the use of a double-sided adhesive sheet to secure construction boards into a roofing system by securing a plurality of construction boards to a roof deck, where the adhesive sheet includes first and second layers of pressure-sensitive adhesive sandwiching a foamed carrier layer, the first layer of pressure-sensitive adhesive forming a bottom surface of the adhesive sheet and the second layer of pressure-sensitive adhesive forming an upper surface of the adhesive sheet.

### BRIEF DESCRIPTION OF THE DRAWINGS

FIG. 1 is a cross-sectional side view of a roofing system according to embodiments of the present invention.

FIG. 2 is a cross-sectional side view of a roofing system according to embodiments of the present invention.

FIG. 3 is a cross-sectional side view of a double-sided adhesive composite sheet in the form of a roll.

### DETAILED DESCRIPTION OF ILLUSTRATIVE EMBODIMENTS

Embodiments of the invention are based, at least in part, on the discovery of a flat or low-sloped roof system wherein one or more layers of construction boards are adhered into the system with a double-sided foam adhesive sheet. While double-sided tapes have been used in the construction industry, the use of double-sided adhesive sheets with a foamed carrier layer has yielded unexpected benefit when used to adhere construction boards, particularly foamed construction boards. For example, when a double-sided adhesive sheet with a foamed carrier layer is employed to secure construction boards into the system, the adhesive sheet has been found to not be the point of failure when subjected to wind uplift testing. It is believed that the nature of the foamed carrier advantageously allows the adhesive sheet to securely mate the foamed construction board even though the contact surfaces of foamed construction boards are often irregular. Also, where the double-sided adhesive sheet is applied as a continuous layer, the use of the double-sided adhesive sheet advantageously provides a vapor barrier layer for the roof system. Further, the present invention provides an efficient method for constructing roof systems by using the double-sided adhesive sheet for securing construction boards including constructions boards with a variety of facer materials.

### Roof System

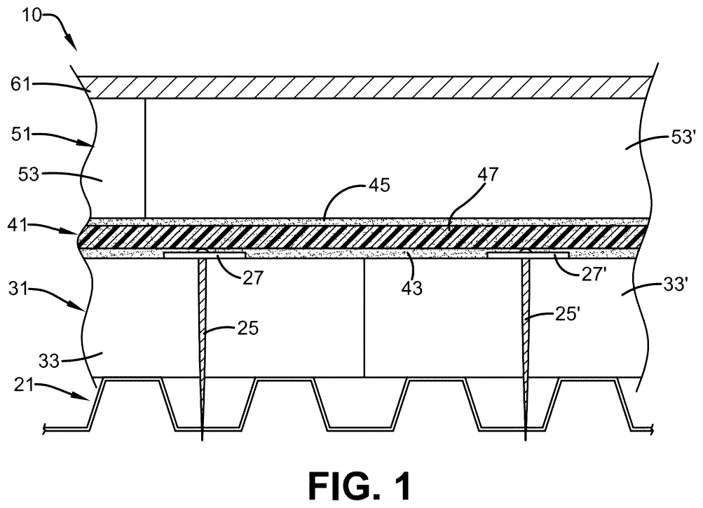

Embodiments of the present invention can be described with reference to FIG. 1, which shows roof system 10 including roof deck 21, a first layer of construction boards 31, a second layer of construction boards 51, and a roofing membrane layer 61. In one or more embodiments, first layer of construction boards 31 is mechanically fastened to roof deck 21 via a mechanical attachment system, which may include fasteners 25, 25′ and fastening plates 27, 27′. As shown in FIG. 1, first layer of construction boards 31 includes individual construction boards 33, 33′. As a skilled person appreciates, first layer of construction boards 31 may include a plurality of construction boards arranged in a pattern that may be conventionally employed in the art, such as a staggered pattern. Similar to first layer of construction boards 31, the skilled person appreciates that second layer of construction boards 51 may include a plurality of construction boards arranged in a pattern that may be conventionally employed in the art, such as a staggered pattern. As shown in FIG. 1, second layer of construction boards 51 includes individual construction boards 53, 53′. The skilled person appreciates that multiple fasters, and corresponding fastening plates, are used to secure each of the individual boards within first layer of construction boards 31 to roof deck 21.

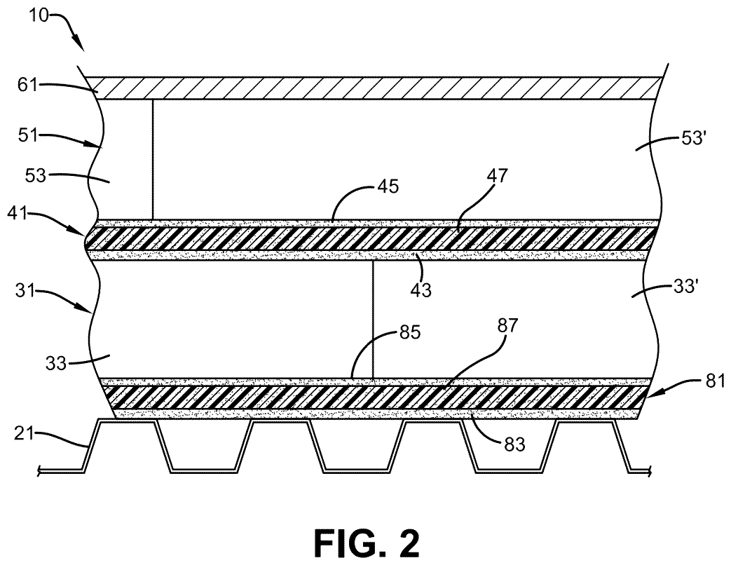

In accordance with practice of the present invention, second layer of construction boards 51 is adhered to first layer of construction boards 31 through double-sided adhesive sheet 41, which may simply be referred to as an adhesive sheet 41. Adhesive sheet 41 includes a first pressure-sensitive adhesive layer 43, which may also be referred to as first adhesive layer 43, and a second pressure-sensitive adhesive layer 45, which may be referred to as second adhesive layer 45. First adhesive layer 43 and second adhesive layer 45 sandwich a foam carrier layer 47, which may also be referred to as foamed carrier 47 or foam carrier 47. As shown in FIG. 1, first adhesive layer 43 adhesively mates to first layer of construction boards 31, and second adhesive layer 45 adhesively mates to second layer of construction boards 51. In other words, as shown in FIG. 2, a double-sided adhesive sheet 81 is employed to adhere first layer of construction boards 31 to roof deck 21. Similar to adhesive sheet 41, adhesive sheet 81 includes a first pressure-sensitive adhesive layer 83, a second pressure-sensitive adhesive layer 85, and a foamed carrier layer 87 sandwiched therebetween. While the embodiments shown in FIGS. 1 and 2 include two layers of construction boards, the skilled person appreciates that the concepts can be extended to three or more layers of construction boards with the adhesive sheet adhering two or more of the layers together.

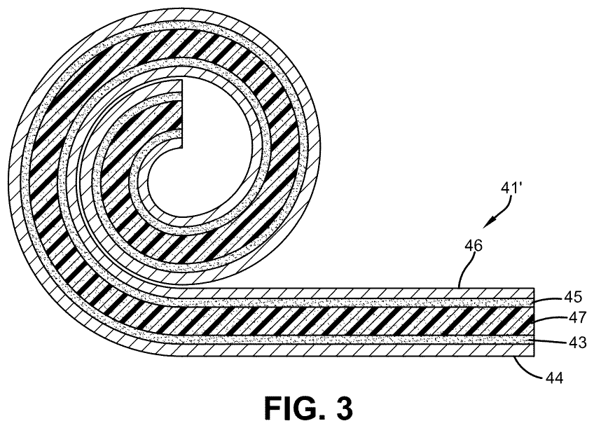

Prior to being installed into the roof system, the adhesive sheet may be in the form of a roll with at least one release member protecting the adhesive layers. For example, as shown in FIG. 3, double-sided adhesive composite sheet 41′, which is in the form of a roll, includes first pressure-sensitive adhesive layer 43, second pressure-sensitive adhesive layer 45, and foam carrier layer 47. A first release member 44 protects first adhesive layer 43, and an optional second release member 46 protects second adhesive layer 45. In other embodiments, release member 44 is adapted to provide release on both planar surfaces and therefore the adhesive sheet can be rolled with only one release member.

### Roof Deck

Practice of this invention is not limited by the selection of any particular roof deck. Accordingly, the roofing systems of this invention can include a variety of roof decks. Exemplary roof decks include concrete pads, steel decks, wood beams, and foamed concrete decks.

### First and Second Layers of Construction Boards

Generally, practice of the invention is not necessarily limited by the selection of particular construction boards that are used to form the one or more layers of construction boards. Those skilled in the art understand the various construction boards that are used within a roofing system. For example, useful construction boards may include, but are not limited to, foam boards (e.g. polystyrene or polyisocyanurate board stock), fiber boards (e.g. OSB boards), masonite boards, gypsum boards (e.g. DensDeck), and perlite boards. As the skilled person appreciates, fiber boards, masonite boards, gypsum boards, perlite boards, and high-density foam boards are often referred to as cover boards, while low-density boards are often referred to as insulation boards.

In one or more embodiments, the first and second layers of construction boards are polyisocyanurate foam boards, which may also be referred to as ISO boards or polyisocyanurate board stock. In one or more embodiments, these foam boards generally include a foam body with optional facers on the opposed planar surfaces of the foam body.

The skilled person appreciates that the foam body of the foam construction boards (i.e. the polyisocyanurate and/or polyurethane foam) can be manufactured by mixing a first stream that includes an isocyanate-containing compound with a second stream that includes an isocyanate-reactive compound. Using conventional terminology, the first stream (i.e., the stream including an isocyanate-containing compound) may be referred to as an A-side stream, an A-side reactant stream, or simply an A stream. Likewise, the second stream (i.e., the stream including an isocyanate-reactive compound) may be referred to as a B-side stream, B-side reactant stream, or simply B stream. In any event, the reaction that ensues produces a foam that, according to one or more kinetic and/or thermodynamic properties, develops over a period of time. Unless otherwise specified, therefore, the term developing foam will be understood to refer to the mixture of the polyurethane and/or polyisocyanurate reactants as they exist prior to cure, which is when the reaction mixture is appreciably immobile (e.g., is no longer flowable).

The skilled person also understands that the foam body of the foam construction boards may be a cellular structure that may include an interconnected network of solid struts or plates that form the edges and faces of cells. These cellular structures may, in one or more embodiments, also be defined by a “relative density” that is less than 0.8, in other embodiments less than 0.5, and in other embodiments less than 0.3. As those skilled in the art will appreciate, “relative density” refers to the density of the cellular material divided by that of the solid from which the cell walls are made. As the relative density increases, the cell walls thicken and the pore space shrinks such that at some point there is a transition from a cellular structure to one that is better defied as a solid containing isolated pores.

In one or more embodiments, the foam body of the foam construction boards may be characterized by a desired ISO index. As the skilled person understands, ISO index correlates to PIR/PUR ratio and can determined by IR spectroscopy using standard foams of known index (note that ratio of 3 PIR/PUR provides an ISO Index of 300), of greater than 150, in other embodiments greater than 180, in other embodiments greater than 200, in other embodiments greater than 220, in other embodiments greater than 240, in other embodiments greater than 260, in other embodiments greater than 270, in other embodiments greater than 285, in other embodiments greater than 300, in other embodiments greater than 315, and in other embodiments greater than 325. In these or other embodiments, the foam may be characterized by an ISO index of less than 350, in other embodiments less than 300, in other embodiments less than 275, in other embodiments less than 250, in other embodiments less than 225, and in other embodiments less than 200.

In one or more embodiments, one layer of construction boards includes polyisocyanurate foam board characterized by a relatively low density (i.e. low-density foam boards), and one layer of construction boards includes polyisocyanurate foam board characterized by a relatively high density (i.e. high-density foam boards). With reference to FIGS. 1 and 2, the foam board having a relatively low density is the first layer of construction boards on or proximate to the roof surface. In one or more embodiments, this layer is mechanically attached to the roof deck as shown in FIG. 1. In other embodiments, this layer is adhered to the roof deck via an adhesive sheet as shown in FIG. 2. The second layer of construction boards, which is disposed above the first, is a layer of foam boards having a relatively high density. Consistent with practice of this invention, the second layer is adhered to the first layer via the adhesive sheet. In one or more embodiments the first and second layers of construction boards both include foam boards characterized by a relatively low density, and then an optional third layer of construction board is disposed over the first and second layers, where the third layer of construction boards may include coverboards (e.g. high density foam boards). The third layer may be adhered to the second layer via an adhesive sheet in accordance with the present invention.

In one or more embodiments, the foam boards that include polyisocyanurate foam characterized by a relatively low density have a density, defined according to ASTM ASTM C 303-21, of less than 2.5 pounds per cubic foot (12.2 kg/m²), in other embodiments less than 2.0 pounds per cubic foot (9.8 kg/m²), in other embodiments less than 1.9 pounds per cubic foot (9.3 kg/m²), and still in other embodiments less than 1.8 pounds per cubic foot (8.8 kg/m²). In one or more embodiments, foam characterized by a relatively low density has a density that is greater than 1.50 pounds per cubic foot (7.32 kg/m²) and in other embodiments greater than 1.55 pounds per cubic foot (7.57 kg/m²).

In one or more embodiments, the foam boards that include polyisocyanurate foam characterized by a relatively high density have a density, defined according to ASTM C 303-21, of greater than 2.5 pounds per cubic foot (12.2 kg/m²), in other embodiments the density is greater than 2.8 pounds per cubic foot (13.7 kg/m²), in other embodiments greater than 3.0 pounds per cubic foot (14.6 kg/m²), and still in other embodiments greater than 3.5 pounds per cubic foot (17.1 kg/m²). In one or more embodiments, the density of this high density boards may be less than 20 pounds per cubic foot (97.6 kg/m²), in other embodiments less than 10 pounds per cubic foot (48.8 kg/m²), in other embodiments less than 6 pounds per cubic foot (29.3 kg/m²), in other embodiments less than 5.9 pounds per cubic foot (28.8 kg/m²), in other embodiments less than 5.8 pounds per cubic foot (28.3 kg/m²), in other embodiments less than 5.7 pounds per cubic foot (27.8 kg/m²), in other embodiments less than 5.6 pounds per cubic foot (27.3 kg/m²), and still in other embodiments less than 5.5 pounds per cubic foot (26.9 kg/m²).

As described above, the foam boards may include facers. The skilled person appreciates that these facers may be disposed on opposed planar surfaces of the boards. The facers can be the same or different and may include a variety of materials or compositions. Useful facers include aluminum foil, cellulosic fiber mats, reinforced cellulosic fiber mats, craft paper, coated glass fiber mats, uncoated glass fiber mats, chopped glass mats, and combinations thereof. Useful facer materials are known as described in U.S. Pat. Nos. 6,774,071, 6,355,701, RE 36674, 6,044,604, and U.S. Pat. No. 5,891,563, which are incorporated herein by reference.

The thickness of the facer may vary; for example, it may be from about 0.01 to about 1.0 inches thick (0.025-2.54 cm) or in other embodiments from about 0.015 to about 0.050 inches thick (0.04-0.13 cm), or in other embodiments from about 0.015 to about 0.030 inches thick (0.04-0.07 cm).

In other embodiments, the facers may be generally solid, rigid material such as wood, particle, or fiber board. In one or more embodiments, the facer is a wood board such as plywood, luan board, or oriented-strand board (OSB). In other embodiments, the facer board is a particle or fiber board such as fiber boards, masonite board, wall board, gypsum board, gypsum products such as DensDeck, perlite boards, and high-density foam boards. The thickness of the rigid facer can vary; for example, the thickness of the rigid facer can be from about 0.2 to about 1.5 inches (0.51-3.8 cm), or in other embodiments from about 0.25 to about 1.0 inches (0.64-2.54 cm).

In one or more embodiments, facers are optional. Therefore, in one or more embodiments, the construction board may be facerless. The ability to produce facerless construction boards is known as described in U.S. Pat. No. 6,117,375, which is incorporated herein by reference.

### Double-Sided Adhesive Sheet

### Foam Carrier Layer

As indicated above, the double-sided adhesive sheet includes a foam carrier layer, which may also be referred to as a foamed carrier layer or adhesive composite. As is generally understood in the art, a foam is a cellular structure that may include an interconnected network of solid struts or plates (also referred to as matrix) that form the edges and faces of cells. These cellular structures may, in one or more embodiments, also be defined by a “relative density” that is less than 0.8, in other embodiments less than 0.5, and in other embodiments less than 0.3. As those skilled in the art will appreciate, “relative density” refers to the density of the cellular material divided by that of the solid from which the cell walls are made. As the relative density increases, the cell walls thicken, and the pore space shrinks such that at some point there is a transition from a cellular structure to one that is better defied as a solid containing isolated pores. In one or more embodiments, the foam is an open-cell foam. In other embodiments, the foam is a closed-cell foam.

In one or more embodiments, the matrix of the foamed carrier layer may include a thermoplastic resin. Exemplary thermoplastic resins include, but are not limited to, polyolefin resins, polyvinylchloride resins, acrylic resins, and ethylene-vinyl acetate (EVA), and acrylonitrile-butadiene-styrene resin (ABS). In other embodiments, the matrix of the foamed carrier layer includes a thermoplastic elastomer. Exemplary thermoplastic elastomers include, but are not limited to, ethylene vinyl acetate, acrylic resins, and polymer blends including thermoplastic vulcanizates or EPDM, SBR and neoprene blends. In other embodiments, the matrix of the foamed carrier layer is a thermoset material. Exemplary thermoset materials include, but are not limited to, polyurethane, cured EPDM, cured blends of neoprene, EPDM, and SBR, cured blends of neoprene and EPDM, and crosslinked polyolefins. For example, the foam may include a polyethylene or polyethylene copolymer matrix that is e-beam crosslinked.

The foamed carrier employed in the present invention may be characterized by the density of the foam layer, which may be referred to as foam density, prior to being mated to the adhesive layers. As a skilled person appreciates, the density of the foam layer can be determined by ASTM D1056-20 for rubber foams and ASTM D3575-20 for polyolefin (thermoplastic) foams. In one or more embodiments, the density of the foamed carrier layer is greater than 0.8, in other embodiments greater than 1.0, and in other embodiments greater than 1.2 pounds per cubic foot (lbs/ft³). In these or other embodiments, the density of the foamed carrier layer is less than 10, in other embodiments less than 8, in other embodiments less than 6, in other embodiments less than 4, and in other embodiments less than 3 lbs/ft³. In one or more embodiments, the density of the foamed carrier layer may be from about 0.8 to about 10 lbs/ft³, in other embodiments from about 1.0 to about 8 lbs/ft³, in other embodiments from about 1.0 to about 6 lbs/ft³, in other embodiments from about 1.0 to about 4 lbs/ft³, and in other embodiments from about 1.2 to about 3 lbs/ft³.

The foamed carrier employed in the present invention may be characterized by the firmness of the foam, which is determined by ASTM D1056-20 prior to being mated to the adhesive layers. In one or more embodiments, the firmness of the foamed carrier layer may be greater than 0.1 (0.689 kPa), in other embodiments may be greater than 0.25 (1.72 kPa), in other embodiments may be greater than 0.5 (3.45 kPa), in other embodiments may be greater than 1 (6.89 kPa), in other embodiments greater than 3 (20.67 kPa), and in other embodiments greater than 5 psi (34.45 kPa). In these or other embodiments, the firmness of the foamed carrier layer may be less than 15 (103.35 kPa), in other embodiments less than 12 (82.68 kPa), in other embodiments less than 10 (68.90 kPa), in other embodiments less than 8 (55.12 kPa), in other embodiments less than 6 (41.34 kPa), and in other embodiments less than 4 psi (27.56 kPa). In one or more embodiments, the foamed carrier layer may have a firmness of from about 0.1 (0.689 kPa) to about 15 psi (103.35 kPa), 0.5 (3.45 kPa) to about 15 psi (103.35 kPa), in other embodiments from about 2 (13.78 kPa) to about 12 psi (82.68 kPa), in other embodiments from about 1 (6.89 kPa) to about 10 psi (68.90 kPa), in other embodiments from about 1 (6.89 kPa) to about 12 psi (68.90 kPa), and in other embodiments from about 3 (20.67 kPa) to about 10 psi (68.90 kPa).

The foamed carrier employed in the present invention may be characterized by tensile strength, in the machine direction, as determined prior to being mated to the adhesive layers. As a skilled person appreciates, machine direction tensile strength of the foamed carrier layer can be determined by ASTM D412-16. In one or more embodiments, the machine direction tensile strength of the foamed carrier layer is greater than 30 psi (206.70 kPa), in other embodiments greater than 40 psi (275.6 kPa), in other embodiments greater than 50 psi (344.50 kPa), and in other embodiments greater than 60 psi (413.4 kPa). In these or other embodiments, the machine direction tensile strength of the foamed carrier layer is less than 120 psi (826.8 kPa), in other embodiments less than 100 psi (689 kPa), in other embodiments less than 80 psi (551.2 kPa), and in other embodiments less than 50 psi (344.5 kPa). In one or more embodiments, the machine direction tensile strength of the foamed carrier layer may be from about 30 psi (206.7 kPa) to about 100 psi (689 kPa), in other embodiments from about 40 psi (275.6 kPa) to about 90 psi (620.1 kPa), and in other embodiments from about 50 psi (344.5 kPa) to about 80 psi (551.2 kPa).

The foamed carrier employed in the present invention may be characterized by its thickness prior to being mated to the adhesive layers. In one or more embodiments, the thickness of the foamed carrier layer is greater than 100 μm, in other embodiments greater than 250 μm, in other embodiments greater than 500 μm, in other embodiments greater than 1000 μm, in other embodiments greater than 1500 μm, in other embodiments greater than 2000 μm, and in other embodiments greater than 3500 μm. In these or other embodiments, the thickness of the foamed carrier layer is less than 10,000 μm, in other embodiments less than 8000 μm, in other embodiments less than 7000 μm, in other embodiments less than 5000 μm and in other embodiments less than 4000 μm. In one or more embodiments, the thickness of the foamed carrier layer may include from about 500 μm to about 10,000 μm, in other embodiments from about 1000 μm to about 7000 μm, and in other embodiments from about 1500 μm to about 5000 μm.

In one or more embodiments, the foamed carrier layer may be characterized by a Shore A hardness, which may be determined by ASTM D2240-15, prior to being mated with the adhesive layers. In one or more embodiments, the foamed carrier layer is characterized by a Shore A hardness of less than 10, in other embodiments less than 7, in other embodiments less than 4, in other embodiments less than 2, and in other embodiments less than 1. In one or more embodiments, the foamed carrier layer is characterized by a Shore A hardness of from about 0 to about 10, in other embodiments from about 1 to about 7, and in other embodiments from about 2 to about 5.

In one or more embodiments, the foamed carrier layer may be characterized by the deflection strength of the foam, which can be determined by ASTM D3575-20 at 25% deflection, prior to being mated to the adhesive layers. In one or more embodiments, the foamed carrier layer may be characterized by a deflection strength at 25% deflection of less than 15 (103.42 kPa), in other embodiments less than 12 (82.68 kPa), in other embodiments less than 10 (68.90 kPa), in other embodiments less than 8 (55.12 kPa), in other embodiments less than 6 (41.34 kPa), in other embodiments less than 4 psi (27.56 kPa), and in other embodiments less than 2 psi (13.78 kPa). In one or more embodiments, the foamed carrier layer may be characterized by a deflection strength at 25% deflection of from about 1 (6.89 kPa) to about 30 psi (206.84 kPa), in other embodiments from about 1 (6.89 kPa) to about 25 psi (172.37 kPa), in other embodiments from about 2 (13.78 kPa) to about 20 psi (137.90 kPa), and in other embodiments from about 3 (20.67 kPa) to about 15 psi (103.42 kPa).

### Adhesive Layers of Adhesive Sheet

As indicated above, the double-sided adhesive sheet includes a first and second pressure-sensitive adhesive layers disposed on opposite sides the foamed carried layer. In one or more embodiments, the respective pressure-sensitive adhesive layers may have one or more of the same properties. For example, the respective pressure-sensitive adhesive layers may have the same thickness and/or may be compositionally the same. In other embodiments, the respective pressure-sensitive adhesive layers may have distinct characteristics.

In one or more embodiments, the pressure-sensitive adhesive layers of the adhesive sheet may be characterized by a thickness that is greater than 25, in other embodiments greater than 50, in other embodiments greater than 75, in other embodiments greater than 100, in other embodiments greater than 125, and in other embodiments greater than 150 μm. In these or other embodiments, the thickness of the pressure-sensitive adhesive layers of the adhesive sheet is less than 500, in other embodiments less than 400, in other embodiments less than 300, in other embodiments less than 200, and in other embodiments less than 150 μm. In one or more embodiments, the thickness of the pressure-sensitive adhesive layers of the adhesive sheet may be from about 25 to about 500 μm, in other embodiments from about 50 to about 400 μm, and in other embodiments from about 100 to about 300 μm.

In one or more embodiments, the pressure-sensitive adhesive layers include, as major polymeric component, a rubber such as ethylene-propylene-diene rubber, ethylene-propylene rubber, polychloroprene, and/or butyl rubber. In other embodiments, the pressure-sensitive adhesive layers include, as a major component, an acrylic resin or polyacrylate polymer. In these or other embodiments, the pressure-sensitive adhesive may include copolymers that include acrylic and/or acrylate units and optionally one or more functional units that can, upon a stimulus such as heat, crosslink the polymers. Exemplary pressure-sensitive adhesive compositions based upon rubbers are disclosed in U.S. Pat. Nos. 9,296,927, 9,068,038, 8,347,932, and 5,859,114, which are incorporated herein by reference.

In one or more embodiments, the pressure-sensitive adhesive layer may be formed from a solvent-borne or water-borne composition that can be applied to the surface of the foam carrier layer or to a transfer film. As the skilled person appreciates, evaporation or removal of the solvent or water provides the adhesive layer. In one or more embodiments, heat or other energy is imparted to the adhesive layer during or after the evaporation process to thereby initiate crosslinking of the polymers within the adhesive layer.

In other embodiments, the pressure-sensitive adhesive layers are formed from a hot-melt pressure-sensitive adhesive composition that can be melt-extruded onto the surface of the foam carrier or a transfer film. Exemplary melt-extrudable (i.e. hot-melt) pressure-sensitive adhesives include compositions based upon acrylic polymers, polyacrylates, butyl rubber, ethylene vinyl acetate, natural rubber, nitrile rubber, silicone rubber, styrene block copolymers, ethylene-propylene-diene rubber, atactic polyalpha olefins, and/or vinyl ether polymers. In combination with these base polymers, the pressure-sensitive adhesive compositions may include a variety of complementary constituents such as, but not limited to, tackifying resins, waxes, antioxidants, and plasticizers. Pressure-sensitive adhesives that are useful in practicing the present invention are known in the art as described, for example, in U.S. Pat. No. 8,968,853, which is incorporated herein by reference.

In particular embodiments, the adhesive layers include a cured, hot-melt pressure-sensitive adhesives. Cured pressure-sensitive adhesives that are useful in practicing the present invention are known in the art as described, for example, in WIPO Publication No. WO 2015/042258, WO 2017/165868, WO 2017/165870, and WO 2017/165871 which are incorporated herein by reference.

In one or more embodiments, the curable hot-melt adhesive that may be used for forming the cured pressure-sensitive adhesive layer may be an acrylic-based hot-melt adhesive. In one or more embodiments, the acrylic-based holt-melt adhesive is a polyacrylate such as a polyacrylate elastomer. The polyacrylates, which may also be referred to as acrylate-based polymers, may include two or more chemically distinct polyacrylates. In one or more embodiments, useful polyacrylates include one or more units defined by the formula:

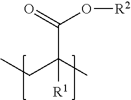

where each R¹ is individually hydrogen or a hydrocarbyl group and each R² is individually a hydrocarbyl group. In the case of a homopolymer, each R¹ and R², respectively, throughout the polymer are same in each unit. In the case of a copolymer, at least two different R¹ and/or two different R² are present in the polymer chain.

In one or more embodiments, hydrocarbyl groups include, for example, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group containing in the range of from 1 carbon atom, or the appropriate minimum number of carbon atoms to form the group, up to about 20 carbon atoms. These hydrocarbyl groups may contain heteroatoms including, but not limited to, nitrogen, oxygen, boron, silicon, sulfur, and phosphorus atoms. In particular embodiments, each R² is an alkyl group having at least 4 carbon atoms. In particular embodiments, R¹ is hydrogen and R² is selected from the group consisting of butyl, 2-ethylhexyl, and mixtures thereof.

In one or more embodiments, the polyacrylate elastomers that are useful in preparing the adhesive layers may be characterized by a glass transition temperature (Tg) of less than 0° C., in other embodiments less than −20° C., in other embodiments less than −30° C. In these or other embodiments, useful polyacrylates may be characterized by a Tg of from about −70 to about 0° C., in other embodiments from about −50 to about −10° C., and in other embodiments from about −40 to about −20° C.

In one or more embodiments, the polyacrylate elastomers that are useful in preparing the adhesive layers may be characterized by a number average molecular weight of from about 100 to about 350 kg/mole, in other embodiments from about 150 to about 270 kg/mole, and in other embodiments from about 180 to about 250 kg/mole.

In one or more embodiments, the polyacrylate elastomers that are useful in preparing the adhesive layers may be characterized by a Brookfield viscosity at 150° C. of from about 20,000 to about 70,000 cps, in other embodiments from about 30,000 to about 60,000 cps, and in other embodiments from about 40,000 to about 50,000 cps.

Specific examples of polyacrylate elastomers that are useful in preparing the adhesive layers include poly(butylacrylate), and poly(2-ethylhexylacryalte). These polyacrylate elastomers may be formulated with photoinitiators, solvents, plasticizers, and resins such as natural and hydrocarbon resins. The skilled person can readily formulate a desirable coating composition. Useful coating compositions are disclosed, for example, in U.S. Pat. Nos. 6,720,399, 6,753,079, 6,831,114, 6,881,442, and 6,887,917, which are incorporated herein by reference.

In other embodiments, the polyacrylate elastomers may include polymerized units that serve as photoinitiators. These units may derive from copolymerizable photoinitiators including acetophenone or benzophenone derivatives. These polyacrylate elastomers and the coating compositions formed therefrom are known as disclosed in U.S. Pat. Nos. 7,304,119 and 7,358,319, which are incorporated herein by reference.

Useful adhesive compositions are commercially available in the art. For example, useful adhesives include those available under the tradename acResin (BASF), those available under the tradename AroCure (Ashland Chemical), and NovaMeltRC (NovaMelt). In one or more embodiments, these hot-melt adhesives may be cured (i.e., crosslinked) by UV light.

In one or more embodiments, the adhesive layers substantially include a cured polyacrylate elastomer. In other words, the adhesive layers are substantially devoid of other constituents such as plasticizers and the like. In one or more embodiments, the adhesive layers include greater than 80 wt %, in other embodiments greater than 85 wt %, in other embodiments greater than 90 wt %, in other embodiments greater than 95 wt %, and in other embodiments greater than 99 wt % of the cured polyacrylate elastomer, based upon the total weight of the adhesive body.

In one or more embodiments, the adhesive layers (e.g. polyacrylate hot-melt adhesive) are at least partially cured after being applied to the foamed carrier layer, as will be discussed in greater detail below. In one or more embodiments, the adhesive is cured to an extent that it is not thermally processable in the form it was prior to cure. In these or other embodiments, the cured adhesive is characterized by a cross-linked infinite polymer network. While at least partially cured, the adhesive layer of one or more embodiments is essentially free of curative residue such as sulfur or sulfur crosslinks and/or phenolic compounds or phenolic-residue crosslinks. In one or more embodiments, the adhesive body is characterized by a degree of cure that can be quantified based upon gel content. As the skilled person appreciates, gel content can be determined based upon the level of insoluble material following solvent extraction, which for purposes of this specification refers to solvent extraction using THF at its boiling point following four hours of extraction. These extraction techniques can be performed, for example, using Soxhlet extraction devices. In one or more embodiments, the gel content of the cured adhesive layer, based upon a THF extraction at the boiling point of THF after four hours, is greater than 20%, in other embodiments greater than 30%, in other embodiments greater than 40%, in other embodiments greater than 50%, in other embodiments greater than 55%, and in other embodiments greater than 60% by weight. In these or other embodiments, the gel content is less than 95%, in other embodiments less than 90%, in other embodiments less than 85%, and in other embodiments less than 80%. In one or more embodiments, the gel content is from about 20% to about 99%, in other embodiments from about 50% to about 95%, in other embodiments from about 55% to about 90%, and in other embodiments from about 60% to about 80% by weight.

In one or more embodiments, the adhesive body may be cured by employing one or more curing techniques including, but not limited to, UV curing, electron beam curing, and thermal curing. In particular embodiments, UV curing is employed, and in this respect, reference can be made to U.S. Publication Nos. 2016/0230392, 2017/0015083, 2017/0114543, 2019/0071872, 2019/0316359, and 2020/0299965.

In one or more embodiments, the cure characteristics of the adhesive layers are substantially homogeneous through the thickness of the adhesive body. In other words, the degree of cure at any given point along the thickness of the adhesive layers does not change appreciably, which refers to deviations that are less than would otherwise have an appreciable impact on the practice of the invention. In other embodiments, the degree of cure varies such that a cure continuum exists from one planar surface to the other planar surface through the thickness of the membrane. In these embodiments, the degree of cure at one planar surface is appreciably greater than the degree of cure at the opposed planar surface such that the adhesive characteristics will be appreciably different at the opposed surfaces to an extent that it will vary practice of the present invention as well as the results thereof.

### Dimensions of Double-Sided Adhesive Sheet

In one or more embodiments, the double-sided adhesive sheet has a thickness of greater than 25, in other embodiments greater than 50, in other embodiments greater than 75, and in other embodiments greater than 100 μm. In these or other embodiments, the double-sided adhesive sheet may have a thickness of less than 890, in other embodiments less than 760, in other embodiments less than 635, in other embodiments less than 508, and in other embodiments less than 380 μm. In one or more embodiments, the double-sided adhesive sheet has a thickness of from about 25 to about 890 μm, in other embodiments from about 50 to about 760 μm, in other embodiments from about 75 to about 635 μm, and in other embodiments from about 100 to about 508 μm.

In one or more embodiments, the double-sided adhesive sheet has a width of greater than 30 cm, in other embodiments greater than 45 cm, in other embodiments greater than 60 cm, and in other embodiments greater than 75 cm. In these or other embodiments, the double-sided adhesive sheet may have a width of less than 15 m, in other embodiments less than 12 m, in other embodiments less than 9 m, and in other embodiments less than 6 m. In one or more embodiments, the double-sided adhesive sheet has a width of from about 30 cm to about 15 m, in other embodiments from about 45 cm to about 12 m, in other embodiments from about 60 cm to about 9 m, and in other embodiments from about 75 cm to about 6 m.

In one or more embodiments, the double-sided adhesive sheet is provided in the form of a roll, and therefore the double-sided adhesive sheet may have an extended length. In one or more embodiments, the double-sided adhesive sheet has a length of greater than 30 cm, in other embodiments greater than 6 m, in other embodiments greater than 10 m, and in other embodiments greater than 50 m. In these or other embodiments, the double-sided adhesive sheet may have a length of less than 900 m, in other embodiments less than 750 m, in other embodiments less than 600 m, in other embodiments less than 300 m, and in other embodiments less than 100 m. In one or more embodiments, the adhesive body has a length of from about 30 cm to about 900 m, in other embodiments from about 6 m to about 750 m, in other embodiments from about 10 m to about 600 m, and in other embodiments from about 20 m to about 300 m.

### Characteristics of Double-Sided Adhesive Sheet

In one or more embodiments, the double-sided adhesive sheet may be characterized by tensile strength measured perpendicular to the planar surface of the foamed layer, which may also be referred to as the Z-direction tensile strength. The skilled person appreciates that Z-direction tensile strength of the foamed carrier layer can be determined by employing an adaptation of ASTM C209, wherein the adaptation included employing a 2 inch×2 inch metal plates (affixed to Instron operating pursuant to the ASTM C209 specification) and adhere each of the respective sides of a 2 inch×2 inch composite (i.e. double-sided sheet) directly to the respective plates. In one or more embodiments, the foamed carrier layer is characterized by a Z-direction tensile strength of greater than 4 psi (27.58 kPa), in other embodiments greater than 5 psi (34.47 kPa), in other embodiments greater than 6 psi (41.37 kPa), in other embodiments greater than 7 psi (48.26 kPa), in other embodiments greater than 10 psi (68.95 kPa), in other embodiments greater than 12 psi (82.74 kPa), in other embodiments greater than 15 (103.42 kPa), and in other embodiments greater than 18 psi (124.11 kPa). In these or other embodiments, the foamed carrier layer is characterized by a Z-direction tensile strength of from about 3 psi (20.68 kPa) to about 45 psi (310.26 kPa), in other embodiments from about 10 psi (68.95 kPa) to about 40 psi (275.79 kPa), and in other embodiments from about 15 psi (103.42 kPa) to about 35 psi (241.32 kPa).

In one or more embodiments, the double-sided adhesive sheet may be characterized by its permeability (or lack thereof). The skilled person appreciates that the permeability of the foamed carrier layer can be determined by ASTM E96/E96M-23. In one or more embodiments, the double-sided adhesive sheet is non-permeable, which refers to a composite characterized by less than 0.1 perms pursuant to ASTM E96/E96M-23. In other embodiments, the double-sided adhesive sheet is semi-impermeable, which refers to a composite characterized by 0.1 to 1.0 perms pursuant to ASTM E96/E96M-23. In other embodiments, the double-sided adhesive sheet is semi-permeable, which refers to a composite characterized by 1.0 to 10 perms pursuant to ASTM E96-/E96M-23.

In one or more embodiments, the double-sided adhesive sheet may be characterized by its bond strength to stainless steel panel, which can be determined by the dead load shear test provided in Pressure Sensitive Tape Council (PSTC) 107, Method A (revised May 2007), at 23° C.+/−1° C. For purposes of this specification, Method A is followed except that polyester film is adhered to the exposed surfaces of the test specimen to ensure that failure occurs at the interface of the adhesive and the stainless steel plate. The sample is aged for one minute after application of the polyester film. In one or more embodiments, double-sided adhesive sheet is characterized by a dead load shear at 22° C. of at least 60 minutes, in other embodiments at least 120 minutes, in other embodiments at least 180 minutes, and in other embodiments at least 240 minutes.

### Release Member

In one or more embodiments, the release liner (e.g. liners 46 and 44), which may also be referred to as release members, includes a polymeric film or extrudate. This polymeric film or extrudate may include a single polymeric layer or may include two or more polymeric layers laminated or coextruded to one another. In other embodiments, the release liner includes a cellulosic substrate having a polymeric film or coating applied thereon, which film or coating may be referred to as a polymeric layer.

Inasmuch as the double-sided adhesive sheet employed in the present invention is typically provided to its location of installation in the form of a roll, the nature and construction of the release member will facilitate this mode of transport, storage and delivery. For example, where the double-sided adhesive sheet includes a single release member, as generally described with reference to FIG. 1 above, then both planar surfaces of the release member will be adapted to removably adhere or attach to the adhesive layers; in other words, the adhesive layers, which are positioned opposite the foamed carrier layer, are removably adhered to the respective surfaces of the release members, which are adapted to release from the adhesive layers.

Suitable materials for forming a release liner that is a polymeric film or extrudate include polypropylene, polyester, high-density polyethylene, medium-density polyethylene, low-density polyethylene, polystyrene or high-impact polystyrene. Suitable materials for forming a polymeric layer on a cellulosic-based release liner include siloxane-based materials, butadiene-based materials, organic materials (e.g., styrene-butadiene rubber latex), as well as those polymeric materials employed to form a film or extrudate as described above. These polymeric materials may offer a number of advantageous properties including high moisture resistance, good resistance to temperature fluctuations during processing and storage, and increased tear and wrinkle resistance. The above referenced films and materials may be coated with a release agent, (e.g., silicone). In one or more embodiments, the release liner includes a static dissipative material. For example, the release liner may include carbon black or metal particles dispersed within a polymeric matrix.

In one or more embodiments, the release member is characterized by a thickness of from about 15 to about 80 μm, in other embodiments from about 18 to about 75 μm, and in other embodiments from about 20 to about 50 μm.

### Manufacture of Double-Sided Adhesive Sheet

The double-sided adhesive sheets of the present invention can be manufactured by employing conventional techniques. For example, a liquid composition including the adhesive material can be applied to respective planar surfaces of the foam carrier material. These compositions can include solvent-borne and water-borne compositions. The skilled person can readily determine the appropriate thickness at which to apply the composition, and then conventional techniques can be employed to evaporate the solvent. Once evaporated, the residue forms the pressure-sensitive adhesive layer. The pressure-sensitive adhesive layers can then optionally undergo further processing such as curing to chemically crosslink the polymers within the layer. In alternate embodiments, the adhesive composition can be applied to the respective layers of the foam carrier by extrusion (i.e. the adhesive materials are melt extruded onto the foam carrier). Once applied to the foam carrier, the adhesive composition can undergo further processing such as chemical crosslinking by, for example, UV curing. In other embodiments, the adhesive composition, either as a melt extrudate or as a liquid composition, can be applied to a release member to form a transfer film composite. The composition can be dried and/or chemically crosslinked to provide the adhesive layer, which is removably attached to the release member. The adhesive layer can then be mated to the foam carrier (i.e. it is laminated to the foam carrier) to form the double-sided adhesive sheet.

### Roofing Membrane Layer

Practice of this invention is likewise not limited by the selection of any particular roofing membrane, which may also be referred to herein as protective membranes. As the skilled person appreciates, roofing membranes provide weather-protective layer to the roofing system. In other words, these membranes are configured to resist environmental conditions experienced on the surface of the roof including water in the form of rain or snow and solar radiation, particularly UV radiation. Useful membranes include those that are known as single-ply roofing membranes. Useful roofing membranes include polymeric membranes. Useful polymeric membranes include both thermoplastic and thermoset materials. For example, and as is known in the art, membrane prepared from poly(ethylene-co-propylene-co-diene) terpolymer rubber or poly(ethylene-co-propylene) copolymer rubber can be used. Roofing membranes made from these materials are well known in the art as described in U.S. Pat. Nos. 6,632,509, 6,615,892, 5,700,538, 5,703,154, 5,804,661, 5,854,327, 5,093,206, and 5,468,550, which are incorporated herein by reference. Other useful polymeric membranes include those made from various thermoplastic polymers or polymer composites. For example, thermoplastic olefin (i.e. TPO), thermoplastic vulcanizate (i.e. TPV), or polyvinylchloride (PVC) materials can be used. The use of these materials for roofing membranes is known in the art as described in U.S. Pat. Nos. 6,502,360, 6,743,864, 6,543,199, 5,725,711, 5,516,829, 5,512,118, and 5,486,249, which are incorporated herein by reference. In one or more embodiments, the membranes include those defined by ASTM D4637/4637M-15 and/or ASTM D6878/6878M-21-21.

Still in other embodiments, the protective membrane can include bituminous or asphalt membranes. In one embodiment, these asphalt membranes derive from asphalt sheeting that is applied to the roof. These asphalt roofing membranes are known in the art as described in U.S. Pat. Nos. 6,579,921, 6,110,846, and 6,764,733, which are incorporated herein by reference. In other embodiments, the protective membrane can derive from the application of hot asphalt to the roof.

Other layers or elements of the roofing systems are not excluded by the practice of this invention. For example, and as is known in the art, another layer of material can be applied on top of the protective membrane. Often these materials are applied to further protect the protective membranes from exposure to electromagnetic radiation, particularly that radiation in the form of UV light. In certain instances, ballast material is applied over the protective membrane. In many instances, this ballast material simply includes aggregate in the form of rock, stone, or gravel; U.S. Pat. No. 6,487,830, is incorporated herein in this regard.

### Method of Assembling Roof System

As suggested above, the methods of this invention employ double-sided adhesive sheet to secure one or more layers of construction boards into a roof system. In particular embodiments, a layer of construction boards is adhered to a substrate, which may include, without limitation, a roof deck or a layer of construction boards. These methods generally include contacting a first adhesive layer of the double-sided adhesive sheet to the substrate (e.g. to a first layer of construction boards). Then, individual boards that form a first or second layer of construction boards is contacted to an exposed opposite adhesive layer of the double-sided adhesive sheet. The methods may include removing a release member where necessary. For example, if the double-sided adhesive sheet includes release members removably mated to each adhesive layer of the adhesive sheet, then a first release member is removed to secure the adhesive sheet to the substrate (e.g. to a first layer of construction boards). Likewise, if the opposed adhesive layer includes a release member, then the opposed release member is removed in order to expose the adhesive layer before placing the individual boards of the subsequent layer of construction boards into contact with the opposed adhesive layer.

Methods of one or more embodiments of the invention can be described in greater detail as follows. According to one or more embodiments, an installation process includes (i) a step of providing a double-sided adhesive sheet, and (ii) a step of providing a first layer of construction boards, which layer of construction boards may be secured to the roof deck. In one or more embodiments, the first layer of construction boards may be mechanically affixed to the roof deck. The method is continued by (iii) a step of positioning the double-sided adhesive sheet on a desired exposed surface of the first layer of construction boards. This step of positioning may include unwinding a roll of the double-sided adhesive sheet. In one or more embodiments, the double-sided adhesive sheet is then secured to the first layer of construction boards. The step of unwinding may include adhering the double-sided adhesive sheet while the roll is being unrolled. Where the adhesive sheet includes a release member removably secured to the adhesive layer adjacent to the substrate (e.g. first layer of construction boards), the process may include a step of removing the lower release member so that the adhesive layer can be contacted and adhered to the substrate (e.g. first layer of construction boards). The skilled person will appreciate that where the composite includes a single release member, the release member can be removably adhered to the opposite adhesive layer of the adhesive sheet, and therefore the act of unrolling the composite allows the adhesive layer to be directly contacted to the substrate without the need to remove the release member. With the adhesive layer exposed, the step of contacting and adhering the adhesive sheet to the substrate (e.g. first layer of construction boards) may include applying force to the upper surface of the adhesive sheet to thereby increase adhesion between the adhesive sheet and the underlying construction board. It will be appreciated that these installation methods include the application of multiple, adjacent strips or sheets of the double-sided adhesive sheet to the substrate. In one or more embodiments, the edges of these respective sheets are abutted to one another. In other embodiments, the edges of the respective sheets are overlapped. In yet other embodiments, a gap (e.g. 0.1-20 cm) is provided between adjacent sheets.

The process continues with a step of optionally removing an upper release member, if present, to thereby expose the upper planar surface of the adhesive layer. Once exposed, the process continues with the step of placing a layer of construction boards into contact with the upper surface of the adhesive sheet (i.e. the upper adhesive layer of the adhesive sheet). The adhesion between the second layer of construction boards and the adhesive sheet, as well as the adhesion between the adhesive sheet and the first layer of construction boards, can be enhanced by a step of applying force (e.g. pressure) to the second layer of construction boards after placing the construction boards in contact with the adhesive sheet.

### Attaching First Layer of Construction Board to Roof Deck

As indicated above with reference to FIG. 1, in one or more embodiments, the first layer of construction boards can be mechanically affixed to the roof deck. This can be accomplished by using known techniques whereby, for example, a board is positioned in place and a plurality of mechanical fastener assemblies, which often include a fastener and a fastening plate, are used to secure the board to the roof deck. In other embodiments, the first layer of construction boards are adhesively secured to the roof deck.

In one or more embodiments, the double-sided adhesive sheet used to adhere the first and second layers of construction boards. For example, according to embodiments of the invention, the double-side adhesive sheet disclosed herein can be employed to secure the first layer of construction boards to the roof deck.

### Attaching Membrane to System

In one or more embodiments, a plurality of membrane panels are secured to the uppermost layer of construction boards and seamed together to form the weather-protective layer of the roof system. In one or more embodiments, the membrane panels are mechanically affixed to the roof system (e.g. mechanically fastened through the layers of construction board to the roof deck). In other embodiments, the membrane panels are adhesively secured to the uppermost layer of construction boards. In particular embodiments, the membrane panels carry a layer of pressure-sensitive adhesive that is used to adhesively mate the membrane panels to the uppermost layer of construction boards. The membrane panels can then be seamed using conventional techniques. For example, it is common to seam rubber membranes by using adhesive tapes or a pressure-sensitive adhesive that is pre-applied to the lap portion of the membrane (which may include the same pressure-sensitive adhesive used to secure the membrane to the roof deck). For thermoplastic membranes, it is typically useful to heat weld the membranes together and thereby form a seam.

In one or more embodiments, the double-sided foam adhesive sheet used to adhere the first and second layers of construction boards can be employed to secure the membrane panes to the uppermost layer of construction boards. The membrane panels can then be seamed using conventional techniques.

Various modifications and alterations that do not depart from the scope and spirit of this invention will become apparent to those skilled in the art. This invention is not to be duly limited to the illustrative embodiments set forth herein.

What is claimed is:

1. A flat or low-sloped roof system comprising:
(i) a roof deck;
(ii) a first layer of construction boards secured directly or indirectly to the roof deck;
(iii) a second layer of construction boards adhered to the first layer of construction boards via a double-sided adhesive sheet that includes a first layer of pressure-sensitive adhesive and a second layer of pressure-sensitive adhesive sandwiching a foamed carrier layer; and
(iv) a roofing membrane forming a waterproof protective layer over the second layer of construction boards.

2. The roof system of claim 1, where the first layer of construction boards includes a plurality of construction boards including foamed polyisocyanurate, and where the second layer of construction boards includes a second plurality of construction boards including foamed polyisocyanurate.

3. (canceled)

4. The roof system of claim 2, where the foamed polyisocyanurate within the first layer of construction boards has a density of less than 48 kg/m³ (3.0 lbs/ft³), and where the foamed polyisocyanurate within the second layer of construction boards has a density of greater than 48 kg/m³ (3.0 lbs/ft³).

5. (canceled)

6. The roof system of claim 1, where the foamed carrier layer is a foamed thermoplastic resin, foamed polyolefin, foamed acrylic resin, foamed elastomer, foamed ethylene vinyl acetate resin, or foamed polyurethane.

7. (canceled)

8. (canceled)

9. (canceled)

10. (canceled)

11. (canceled)

12. The roof system of claim 1, where the foamed carrier layer has a thickness of about 500 to about 10,000 μm.

13. The roof system of claim 1, where the foamed carrier layer is a closed-cell foam.

14. The roof system of claim 1, where the foamed carrier layer is an open-cell foam.

15. The roof system of claim 1, where the foamed carrier layer has a density of from about 12.8 kg/m³ to about 160 kg/m³ (about 0.8 to about 10 lbs per ft³).

16. The roof system of claim 1, where the foamed carrier layer, prior to sandwiching between the first layer of pressure-sensitive adhesive and the second layer of pressure-sensitive adhesive, has a tensile strength, in the machine direction, of about 207 to about 689 kPa (about 30 to about 100 psi).

17. (canceled)

18. (canceled)

19. (canceled)

20. The roof system of claim 1, where the first layer of pressure-sensitive adhesive has a thickness of from about 25 to about 500 μm and where the second layer of pressure-sensitive adhesive has a thickness of from about 25 to about 500 μm.

21. (canceled)

22. (canceled)

23. (canceled)

24. The roof system of claim 1, where the first layer of construction boards is adhered to the roof deck via a second double-sided adhesive sheet that includes a first layer of pressure-sensitive adhesive and a second layer of pressure-sensitive adhesive sandwiching a foamed carrier layer.

25. A method of installing construction boards on a roof, the method comprising:
(i) positioning a double-sided adhesive sheet on a desired exposed surface of a first layer of construction boards secured to a roof deck, the double-sided adhesive sheet including a first layer of pressure-sensitive adhesive and a second layer of pressure-sensitive adhesive sandwiching a foamed carrier layer, where the first layer of the pressure-sensitive adhesive is a bottom surface of the double-sided adhesive sheet and the second layer of pressure-sensitive adhesive is an upper surface of the double-sided adhesive sheet;
(ii) contacting and adhering the bottom surface of the double-sided adhesive sheet to the first layer of construction boards; and
(iii) placing a second layer of construction boards into contact with the upper surface of the double-sided adhesive sheet.

26. (canceled)

27. (canceled)

28. The method of claim 25, where, prior to the contacting and adhering the bottom surface of the double-sided adhesive sheet to the first layer of construction boards, the method further comprises removing a release member removably secured to the bottom surface of the double-sided adhesive sheet to thereby expose the bottom surface of the double-sided adhesive sheet.

29. (canceled)

30. The method of claim 25, where, prior to the placing the second layer of construction boards into contact with the upper surface of the double-sided adhesive sheet, the method further comprises removing an upper release member removably secured to the upper surface of the double-sided adhesive sheet to thereby expose the upper surface of the double-sided adhesive sheet.

31. (canceled)

32. The method of claim 25, further comprising installing an additional layer of construction boards over the second layer of construction boards and/or installing a membrane system over the second layer of construction boards or the additional layer of construction boards.

33. The method of claim 25, where the first layer of construction boards is adhesively secured to the roof deck by a second double-sided adhesive sheet that includes a first layer of pressure-sensitive adhesive and a second layer of pressure-sensitive adhesive sandwiching a foamed carrier layer, the first layer of pressure-sensitive adhesive forming a bottom surface of the second double-sided adhesive sheet and the second layer of pressure-sensitive adhesive forming an upper surface of the second double-sided adhesive sheet.

34. The method of claim 25, where the first layer of construction boards includes a plurality of construction boards including foamed polyisocyanurate, where the second layer of construction boards includes a plurality of construction boards including foamed polyisocyanurate.

35. (canceled)

36. The method of claim 34, where the foamed polyisocyanurate within the first layer of construction boards has a density of less than 48 kg/m³ (3.0 lbs/ft³), where the foamed polyisocyanurate within the second layer of construction boards has a density of greater than 48 kg/m³ (3.0 lbs/ft³).

37. (canceled)

38. The method of claim 25, where the foamed carrier layer is a foamed thermoplastic resin, foamed polyolefin, foamed acrylic resin, foamed elastomer, foamed ethylene vinyl acetate resin, or foamed polyurethane.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. A method of installing construction boards on a roof, the method comprising:
(i) positioning a double-sided adhesive sheet on a desired area of a roof surface, the double-sided adhesive sheet including a first layer of pressure-sensitive adhesive and a second layer of pressure-sensitive adhesive sandwiching a foamed carrier layer, where the first layer of the pressure-sensitive adhesive is a bottom surface of the double-sided adhesive sheet and the second layer of pressure-sensitive adhesive is an upper surface of the double-sided adhesive sheet;
(ii) contacting and adhering the bottom surface of the adhesive sheet to the roof deck; and
(iii) contacting and adhering a plurality of construction boards to the upper surface of the double-sided adhesive sheet to thereby form a layer of construction boards adhered to the roof deck.

58. (canceled)

59. (canceled)

60. (canceled)
